(19) United States
(12) Patent Application Publication
(10) Pub. No.: US 2016/0123885 A1
(43) Pub. Date: May 5, 2016

(54) Inspection Lamp Having Reduction of Speckle of Laser Light

(71) Applicant: Brasscorp Limited, Toronto (CA)

(72) Inventor: Donald L. Klipstein, Upper Darby, PA (US)

(21) Appl. No.: 14/930,466

(22) Filed: Nov. 2, 2015

Related U.S. Application Data
(60) Provisional application No. 62/073,635, filed on Oct. 31, 2014.

(51) Int. Cl. G01N 21/64; G01M 3/20

(52) U.S. Cl. CPC G01N 21/6447; G01M 3/20; G01N 2201/0697; G01N 2201/0612

(57) ABSTRACT

An inspection lamp for detection of fluorescent materials, such as dyes often added to refrigerant fluids for the purpose of detecting leaks. Multiple aspects of reducing a distracting speckle effect are described. For example, at least two aspects are combined. One speckle reduction aspect uses a diffuser. A second speckle reduction aspect is achieved by a laser device such as a laser diode that simultaneously outputs a large number of individual wavelengths across a significant bandwidth. A third aspect of despeckling the laser light includes vibrating or rotating optical components. A fourth aspect of despeckling includes fluorescence and broadband radiation from the laser being more visible through suitable eyewear than the laser radiation.

### CROSS-REFERENCE TO RELATED APPLICATION(S)

This application claims the benefit of the filing date of U.S. Patent Application Ser. No. 62/073,635 filed Oct. 31, 2014 entitled INSPECTION LAMP HAVING REDUCTION OF SPECKLE OF LASER LIGHT, the contents of which are hereby expressly incorporated by reference into the Detailed Description of Example Embodiments hereinbelow.

### FIELD

At least some example embodiments relate to inspection lamps, and more particularly inspection lamps with laser output.

### BACKGROUND

Inspection lamps for detection of fluorescent materials, such as leaks of fluids from refrigeration, climate control, and automotive engine cooling or lubrication systems that have a fluorescent dye added to the relevant fluid, are long known to exist with various technologies.

Before suitable LEDs for modern versions of these inspection lamps became available, such inspection lamps were typically made in a clumsy, bulky, power-hungry, greatly heat-producing way with lamp elements being of typically either mercury vapor or tungsten incandescent type. These lamps required filters to block emission of wavelengths of light that are similar to wavelengths of light that are emitted by fluorescent materials that are desired to be detected, such as a leak from a closed plumbing or refrigeration system that has a fluorescent dye added for the purpose of detecting leaks.

Usage of recently available lamp technology, mainly recently available suitable LEDs, where the lamps are more efficient and/or have a narrower spectrum, results in improvement of the practice of fluorescent leak detection. This resulted in production of inspection lamps with smaller size, lighter weight, less heat production, less power consumption, and greater performance in comparison to older inspection lamps that used non-LED technology.

However, for narrower spectrums, speckling may arise when the light source is output to the fluorescent material and other materials. Additional difficulties with some existing methodologies may be appreciated in view of the Detailed Description of Example embodiments, herein below.

### SUMMARY

In an example embodiment, there is provided an inspection lamp for detection of fluorescent materials, such as dyes often added to refrigerant fluids for the purpose of detecting leaks. Multiple aspects of reducing a distracting speckle effect are described. For example, at least two aspects are combined. One speckle reduction aspect uses a diffuser. A second speckle reduction aspect is achieved by a laser device such as a laser diode that simultaneously outputs a large number of individual wavelengths across a significant bandwidth. A third aspect of despeckling the laser light includes vibrating or rotating optical components. A fourth aspect of despeckling includes fluorescence and broadband radiation from the laser being more visible through suitable eyewear than the laser radiation.

In an example embodiment, there is provided an inspection lamp for detection of fluorescent material with reduced visible laser speckle. The inspection lamp includes a laser device such as a laser diode that generates radiation that is suitable for fluorescing the fluorescent material, wherein the laser device outputs multiple individual laser wavelengths. Various optical layers can be used to affect the radiation. The inspection lamp can include a diffusing layer to diffuse the radiation. The inspection lamp can include a beam shaping layer to form the radiation into a beam, the beam for detecting the fluorescent material. The inspection lamp can include a collimation layer to collimate the radiation. As well, in some example embodiments, a filtration layer can be used, independent of a beam path of the beam, to block at least part or all of the radiation produced by the beam, to reduce visible laser speckle. The filter passes at least some or all of a fluorescence spectrum from the fluorescent material resulting from the beam.

In an example embodiment, there is provided an inspection lamp for detection of fluorescent material with reduced visible laser speckle, including: a laser device that generates radiation that is suitable for fluorescing the fluorescent material, wherein the laser device simultaneously outputs multiple individual laser wavelengths; at least one diffuser that is positioned to diffuse the radiation; and at least one lens which is shaped to form the radiation into a beam, the beam for detecting the fluorescent material.

In an example embodiment, there is provided an inspection system, including the inspection lamp and a filter. The filter is independent of a beam path of the beam, and blocks at least part or all of the radiation produced by the beam to reduce visible laser speckle.

In an example embodiment, there is provided a method of detecting fluorescent material with reduced visible laser speckle, including: generating radiation from a laser device that is suitable for fluorescing the fluorescent material, wherein the laser device simultaneously outputs multiple individual laser wavelengths; diffusing the radiation using at least one diffuser; shaping the radiation into a beam using at least one lens; and irradiating a region of interest with the beam, for detecting of the fluorescent material.

### BRIEF DESCRIPTION OF THE DRAWINGS

Example embodiments will now be described by way of examples with reference to the accompanying drawings, in which like reference numerals may be used to indicate similar features, and in which:

FIG. 1 illustrates a diagrammatic perspective view of an example optical train, in accordance with an example embodiment;

FIG. 2 illustrates a diagrammatic top view of the optical train shown in FIG. 1;

FIG. 3 illustrates a diagrammatic side view of the optical train shown in FIG. 1;

FIG. 4 illustrates a diagrammatic perspective view of another example optical train, in accordance with another example embodiment;

FIG. 5 illustrates a diagrammatic perspective view of another example optical train, in accordance with another example embodiment;

FIG. 6 illustrates a diagrammatic perspective view of another example optical train, in accordance with another example embodiment;

FIG. 7 illustrates a diagrammatic side view of an example inspection lamp, in accordance with an example embodiment;

FIG. 8 illustrates a diagrammatic view of an example system for use of the inspection lamp of FIG. 7, in accordance with an example embodiment;

FIG. 9 illustrates a diagrammatic side view of another example inspection lamp, which includes a laser pointer, in accordance with an example embodiment;

FIG. 10 illustrates a diagrammatic perspective view of an example concave cylindrical lens, for use in at least some example embodiments;

FIG. 11 illustrates a diagrammatic perspective view of another example optical train, in accordance with another example embodiment;

FIG. 12 illustrates a diagrammatic perspective view of an example cylindrical convex lens, for use in at least some example embodiments;

FIG. 13 illustrates a diagrammatic top view of another example optical train, in accordance with another example embodiment;

FIG. 14 illustrates a diagrammatic top view of another example optical train, in accordance with another example embodiment; and

FIG. 15 illustrates a diagrammatic top view of another example optical train, in accordance with another example embodiment.

### DETAILED DESCRIPTION OF EXAMPLE EMBODIMENTS

The recent availability of high-power laser diodes with a narrower spectrum offers opportunity for improvement of the practice of detecting fluorescence of fluid leaks or other fluorescent materials, for example by using a blue light source, and for example a yellow pair of goggles or similar barrier filter.

In an example embodiment, there is provided an inspection lamp for detection of fluorescent material with reduced visible laser speckle. The inspection lamp includes a laser device such as a laser diode that generates radiation that is suitable for fluorescing the fluorescent material, wherein the laser device outputs multiple individual laser wavelengths. Various optical layers can be used to affect the radiation. The inspection lamp can include a diffusing layer to diffuse the radiation. The inspection lamp can include a beam shaping layer to form the radiation into a beam, the beam for detecting the fluorescent material. The inspection lamp can include a collimation layer to collimate the radiation. As well, in some example embodiments, a filtration layer can be used, independent of a beam path of the beam, to block at least part or all of the radiation produced by the beam, to reduce visible laser speckle. The filter passes at least some or all of a fluorescence spectrum from the fluorescent material resulting from the beam.

In an example embodiment, there is provided an inspection lamp for detection of fluorescent material with reduced visible laser speckle, including: a laser device that generates radiation that is suitable for fluorescing the fluorescent material, wherein the laser device simultaneously outputs multiple individual laser wavelengths; at least one diffuser that is positioned to diffuse the radiation; and at least one lens which is shaped to form the radiation into a beam, the beam for detecting the fluorescent material.

In an example embodiment, there is provided an inspection system, including the inspection lamp and a filter. The filter is independent of a beam path of the beam, and blocks at least part or all of the radiation produced by the beam to reduce visible laser speckle.

In an example embodiment, there is provided a method of detecting fluorescent material with reduced visible laser speckle, including: generating radiation from a laser device that is suitable for fluorescing the fluorescent material, wherein the laser device simultaneously outputs multiple individual laser wavelengths; diffusing the radiation using at least one diffuser; shaping the radiation into a beam using at least one lens; and irradiating a region of interest with the beam, for detecting of the fluorescent material.

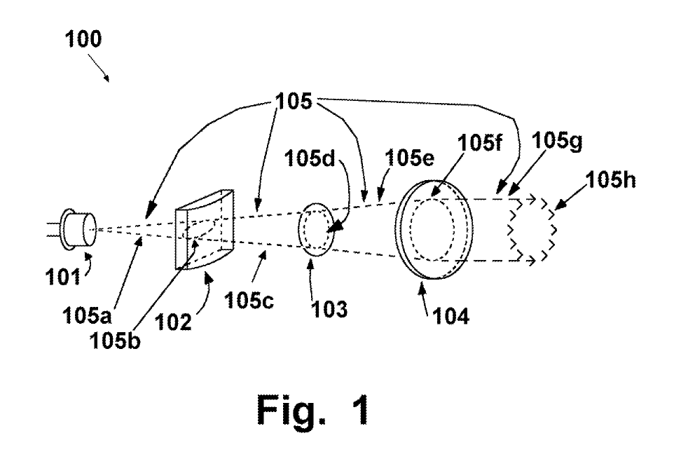

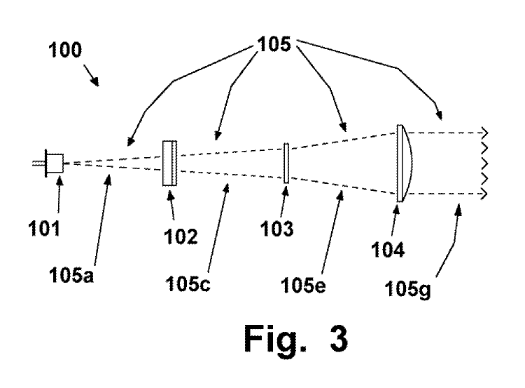

Referring to FIGS. 1, 2, and 3, an example embodiment of an optical train 100 of a cylindrical convex lens 102, a diffuser 103, and a non-cylindrical convex lens 104 are shown as processing a beam 105 of light or other electromagnetic radiation that is emitted by a laser diode 101.

The beam 105 emitted from the laser diode 101 is shown as having a section 105a before being processed by any of the optical components in the optical train 100. Also shown is a beam section 105c after the beam 105 is processed by the cylindrical convex lens 102, a beam section 105e after the beam 105 is processed by the diffuser 103, and the fully processed beam 105g after being processed by the non-cylindrical convex lens 104.

FIG. 1 shows effects of the optical components 102, 103, 104. The beam section 105a is emitted by the laser diode 101 as diverging in an oblong pattern, shown as the beam shape 105b where the beam 105 is at the cylindrical lens 102. The effect of the cylindrical convex lens 102, in an example embodiment, is to halt further expansion of the beam 105 in the longer dimension of its oblong expansion pattern 105b, without affecting expansion of the beam in the shorter dimension of the oblong expansion pattern of the expansion of the beam 105. The desired result is for the beam's shape to be non-oblong as shown as the beam's shape 105d where the beam enters the diffuser 103.

One result of the diffuser 103 is to add divergence of the beam, as shown in the beam region 105e between the diffuser 103 and the non-cylindrical convex lens 104.

The lens 104 is shown as collimating the diverging beam segment 105e into a collimated output beam 105f, which maintains its circular shape at any point afterwards 104h.

In other example embodiments, other optical arrangements may be used for achieving this effect. For example, the beam segment 105c may expand unequally in 2 dimensions as it progresses, or it may contract in one dimension while expanding in another. This can alternatively be accomplished by the cylindrically convex lens being altered to having its curvature in the two dimensions perpendicular to the axis of the beam 105, and parallel to the axes of oblongation of the beam segment 105a as shown in the beam shape 105b, merely unequal to each other. The cylindrical lens 102 merely has to be more convex or less concave in the dimension affecting the longer dimension of the oblong beam shape 105b than in the shorter dimension of the beam shape 105b. Further alternatively, the desired beam shaping effect can be achieved with more than one lens to achieve the effect of the lens 102, for example a combination of a cylindrical lens and a non-cylindrical lens.

Further alternatively, an oblong beam may be tolerable, possibly even desirable for some applications.

The optical train 100 and usage of the diffuser 103 reduces the grain size of “laser speckle”, in comparison to some other conventional optical arrangements that do not have a diffuser 103.

Further speckle reduction may be accomplished by combining the optical train 100, including the diffuser 103, with a laser diode 101 that is e.g. of a type that emits multiple individual wavelengths of laser light over a range of around a nanometer in some example embodiments, or more in other example embodiments. Laser diodes that emit multiple wavelengths through a range of around a nanometer or more include ones with desired wavelength of near 445 nm, and laser light power output of around 0.4-1 watt, or greater. Such laser diodes are used in many “pico projectors”, for example.

In some example embodiments, the laser diode 101 is a pulsing laser diode, resulting in output of a pulsed laser light. For example, pulsating can reduce an amount of energy consumed, such when a portable power supply is used. In an example embodiment, the laser diode 101 is driven by circuitry and/or controller which provides an input pulse drive. In another example embodiment, the laser diode itself is of a type which can provide a pulsed laser light in response to a constant input drive, for example with integrated circuitry and/or controller. In some example embodiments, the pulse rate is specified and can range from 2 to 8 Hertz. In some example embodiments, the pulse has a 50% duty cycle. In some example embodiments, the pulse has less than 50% duty cycle, for example if the laser diode 101 has a suitably high peak output power.

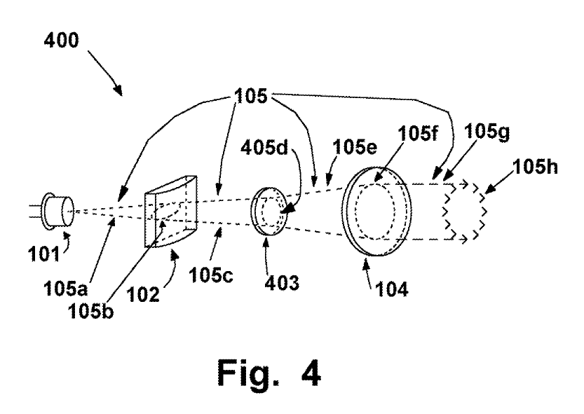

Referring to FIG. 4, in an example embodiment, an alternative optical train 400 is shown, which includes the laser diode 101, cylindrical lens 102, and non-cylindrical lens 104 of FIGS. 1-3, and having an additional non-cylindrical lens 403 in place of the diffuser 103 of FIGS. 1-3. The additional non-cylindrical lens 403 is preferably concave, causing the laser radiation beam 105 to diverge as a result of passing through an intercepted region 405d of the lens 403.

The non-diffusing alternative optical train 400 may be acceptable if speckle in the visible laser radiation exiting from the non-cylindrical lens 104 is sufficiently mitigated by the visible laser radiation emitted by the laser diode 101 having a sufficiently large number of wavelengths or a continuous spectrum throughout a sufficiently wide bandwidth. Blue laser diodes are available which can individually emit at least 20 distinct wavelengths over a bandwidth of more than 2 nanometers. The non-diffusing alternative optical train 400 may also be acceptable if the visible laser radiation is blocked from view, for example by a filtration layer including a barrier filter such as goggles (not shown) that block the laser radiation but pass longer wavelengths of visible light that is emitted by fluorescent materials being irradiated by the laser radiation.

It has been found that sufficiently intense irradiation of most objects by radiation of wavelengths near 445 nanometers causes at least some fluorescence that is visible to human vision through suitable yellow goggles. This fluorescence is often weakly emitted by proteins in organic materials, including pollen grains, mold spores, bacteria, microscopic fragments of exfoliated skin, and fragments of feces and shedded exoskeletons of dust mites. This fluorescence is typically sufficiently visible through suitable yellow goggles to allow visibility of an area being irradiated by the laser radiation exiting the non-diffusing optical train 400, and lacks the speckle characteristic of most laser illumination. Even though this visible fluorescence is usually present, it typically does not interfere with visibility of objects that are intended to fluoresce. For example, with suitable irradiation by wavelengths around 445 nanometers and suitable yellow goggles, a single grain of a fluorescent powder intended for revealing fingerprints can be visible from a few feet away even if it is on a surface that has visible background fluorescence from organic materials.

An alternative mechanism for producing visible dim speckle-free illumination of an area irradiated by laser radiation emitted by the laser diode 101 is production of a small quantity of longer wavelength broadband visible non-laser light that may also be emitted by the laser diode 101. Laser diodes are known to emit small amounts of non-laser radiation over a wide bandwidth of wavelengths including wavelengths longer than that of the laser radiation. In the case of the blue laser diode 101, such longer wavelengths include ones visible through suitable yellow goggles.

It has been found useful for the area being irradiated by an inspection lamp to be dimly visible, to draw attention to the irradiated area.

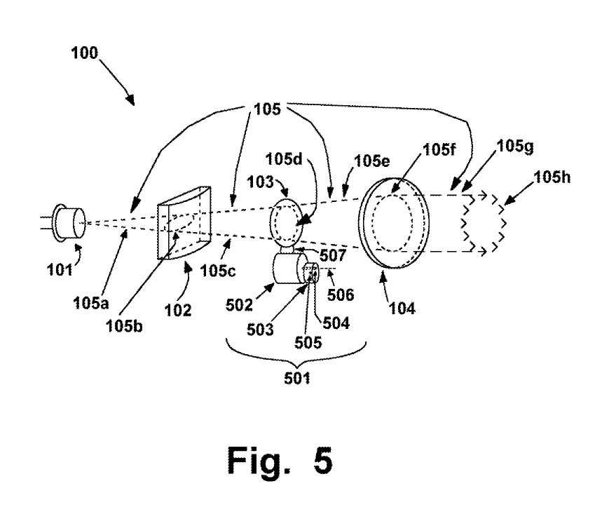

Referring to FIG. 5, in an example embodiment, the optical train 100 is shown, along with a vibrator 501 to vibrate the diffuser 103. The vibrator 501 is shown as a motor 502 that has a weight 503 that is attached to the motor's shaft 504, in a manner such that the weight's center of gravity 505 does not coincide with the axis 506 of the motor's shaft 504. The motor 502 is shown as attached to the diffuser 103 by an adhesive such as glue 507. Other fasteners or mechanisms for connecting the vibrator 501 to the diffuser 103 may be used in other example embodiments.

Alternative devices for achieving vibration, such as a linear motor or a piezoelectric transducer, are used in other example embodiments. Two linear motors or piezoelectric motors may be used with appropriate mechanical connections and driving circuitry to achieve circular or other non-linear vibration of the diffuser 103. Alternatively, linear vibration of the diffuser 103 may be found to be acceptable in some other example embodiments.

Achieving vibration of the diffuser 103 accomplishes further reduction of the visibility of speckle in the laser radiation exiting the optical train 100.

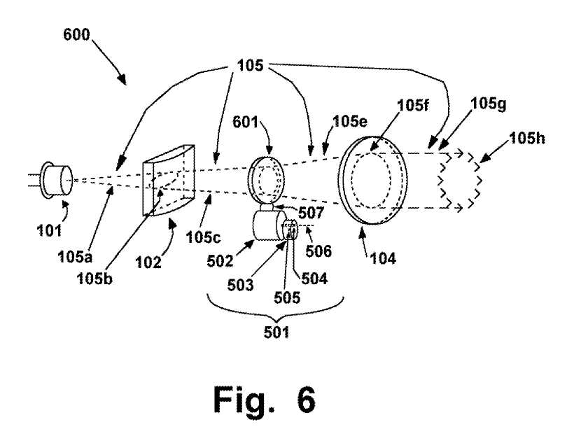

Referring to FIG. 6, in an example embodiment, an alternative optical train 600 is shown with a vibrator 501. The alternative optical train 600 is shown as being similar to the optical train 100 of FIGS. 1-3, and having in addition a non-cylindrical lens 601 being vibrated by the vibrator 501 instead of the diffuser 103 of FIGS. 1-3 and 4. This assists in further reduction of the visibility of speckle in the laser radiation exiting the optical train 100.

Referring again to FIG. 5, instead of or in addition to the vibrator 501, a rotator (not shown) can be positioned to rotate the diffuser 103. This assists in further reduction of the visibility of speckle in the laser radiation exiting the optical train 100. For example, a motor shaft can be circumferentially engaged to the circumference of diffuser 103, wherein rotation of the motor shaft therefore rotates the diffuser. In another example embodiment, a gear is mounted to the motor shaft, and the diffuser 103 includes teeth which are circumferentially positioned thereon and which interact with the gear to rotate the diffuser 103.

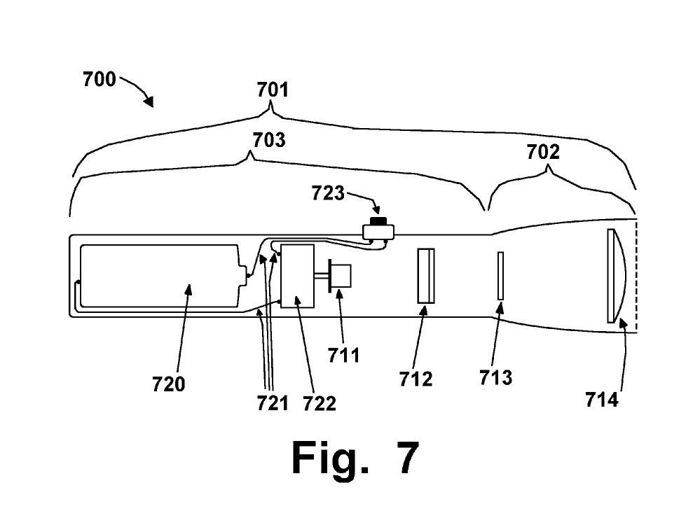

Referring to FIG. 7, in an example embodiment, an inspection lamp 700 is shown as comprising in part a housing 701 which has a head section 702 and a handle section 703. The inspection lamp is shown as being handholdable, and resembling a flashlight, in some example embodiments.

The inspection lamp 700 is shown as further comprising a laser diode 711, cylindrical convex lens 712, diffuser 713, and a non-cylindrical convex lens 714, in an example arrangement like that of at least some or all of the optical train 100 of FIGS. 1-3.

The inspection lamp 700 is shown as further comprising a power supply to the laser diode 711, for example a battery 720, wires 721, a current controller 722, and a switch 723. The battery 720 may or may not be rechargeable. The battery 720 can be a separate battery pack in some example embodiments. Alternatively, the inspection lamp 700 may receive power from an external source such as line power, power from a power adapter, or automotive power. The current controller 722 is used to control or limit the magnitude of current flowing through the laser diode 711, and may for example be a current regulator, a boost converter with power regulation or limiting characteristics, or a resistor.

Arrangements that are alternatives to the arrangement of the inspection lamp 700 may be used in other example embodiments. For example, the diffuser 703 may be omitted, or a vibrator (not shown) such as the vibrator 501 of FIGS. 5-6 may be added.

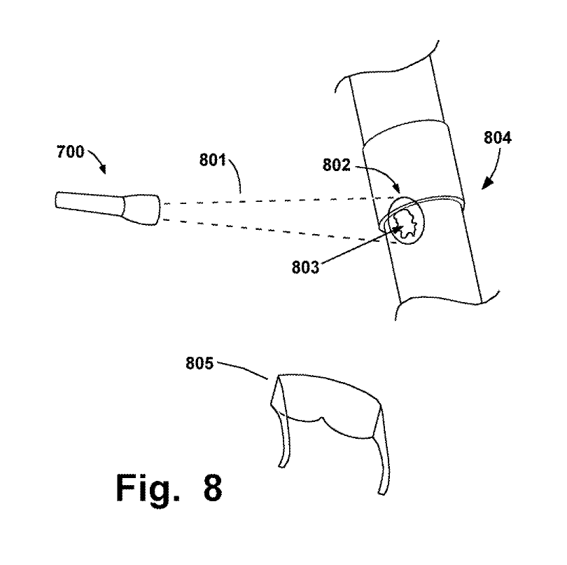

Referring to FIG. 8, in an example embodiment, an inspection lamp 700 produces a beam 801 of radiation suitable for causing fluorescence of materials in an irradiated area 802 that is illuminated by the beam 801, for example a fluid leak 803 from plumbing 804. The fluid leak 803 in this example is fluorescent because the leaked fluid includes a fluorescent dye. Visibility of the fluorescent leak 803 is typically enhanced by viewing the fluorescent leak 803 through a barrier filter such as goggles 805 that pass the wavelengths of light emitted by the fluorescence from the leak 803, while blocking the wavelength range of radiation emitted by the inspection lamp 700.

The goggles 805 are yellow in some example embodiments. Other colors of goggles 805 or any similar barrier filter may be used, depending on the wavelengths emitted by the inspection lamp 700 and fluorescent materials to be detected such as the shown fluorescent leak 803.

In some example embodiments, total radiation output from the inspection lamp 400 may be configured to be around 0.4 to 1 watt. This may require the laser diode 101 to have optical power output in the range of 1 to 3 watts, which is currently available.

Speckle reduction of an irradiation area 802 may be achieved, in whole or in part, by having the goggles 805 blocking most or all of the laser radiation emitted by the inspection lamp 700, while passing most of the fluorescence from the irradiation area 802, or passing a visible quantity of longer-wavelength non-laser light produced by the inspection lamp 700. Even when nominally fluorescent materials that are being searched for are absent, the irradiation area 802 typically reflects sufficient non-laser light or produces sufficient weak fluorescence from stray weakly fluorescent materials (not shown) to be visible through the goggles 805 without the distracting speckle that is typical of laser illumination.

Such stray weakly fluorescent materials include specks of biological matter, which often includes formerly airborne matter. Such matter includes specks of shedded human or other animal skin material, pollen grains, mold and fungus spores, bacteria and virii, and grains of dust from dessicated deceased organisms or parts thereof, and grains of dust from exfoliated skin, fragments of shedded exoskeletons of dust mites, and dessicated waste products from dust mites or other organisms. Biological matter may include traces of skin secretions and excretions resulting from past contact with human skin. Such biological materials tend to have a weak fluorescence that is visible from irradiation by a sufficiently powerful and otherwise suitable laser inspection lamp 700 that is combined with a suitable barrier filter such as a pair of yellow goggles 805 that sufficiently blocks the visible laser radiation in the beam 801.

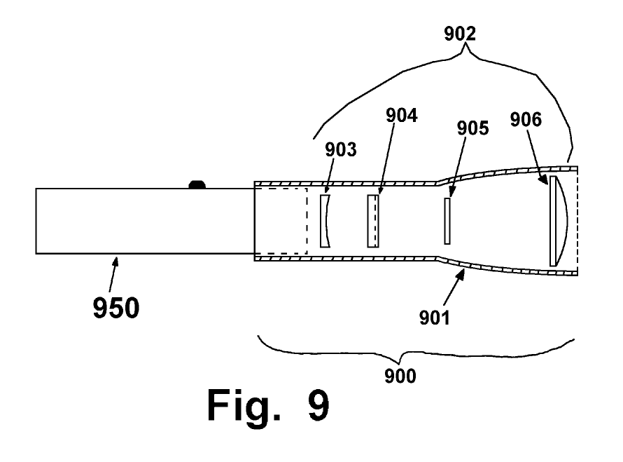

Referring to FIG. 9, in an example embodiment, a module 900 is attached to a laser pointer such as a blue laser pointer 950 to achieve an inspection lamp suitable for detection of fluorescent materials by altering the characteristics of the beam produced by the blue laser pointer 950.

Hereinafter in the description of items shown in FIG. 9, the beam produced by the blue laser pointer 950 is simply referred to as the beam.

The module 900 has a housing 901 and an optical train 902. The optical train 902 is shown to comprise a concave lens 903 to cause the beam to diverge, and a concave cylindrical lens 904 to cause additional divergence of the beam in only one dimension to remove an oblong characteristic of most laser pointer beams. Although as shown the beam is processed by the concave lens 903 before it is processed by the concave cylindrical lens 904, the beam can be processed by these lenses in either order.

The two lenses 903, 904 may be substituted by a single concave lens that causes divergence by different amounts in two different dimensions perpendicular to each other. This may be accomplished by having both of its surfaces being concave cylindrical, with their axes perpendicular to each other and different in amount of curvature. This may also be accomplished by having one concave surface being spherical or an aspheric figure of rotation, and the other concave surface being concave cylindrical. Other approaches are possible, including the lens having a concave surface whose radius of curvature is unequal about two perpendicular axes.

The optical train 902 is shown as further comprising a diffuser 905 and a convex lens 906. The diffuser 905 is placed at a location where the beam becomes no longer oblong. As the final part of processing the beam, the lens 906 projects an image of the area of the diffuser 905 that intercepts the beam.

Alternatively, in an example embodiment, the module 900 may have the simpler optical train 100 of FIG. 1. In this case, the laser pointer 950 would have removed from it the collimating lens that laser pointers using diode lasers typically have.

The module 900 may be constructed to allow the laser pointer 950 and the module 900 to be rotated with respect to each other about a common axis to adjust the optical results. The module 900 may be constructed to allow adjustment of the spacing between the output aperture (not shown) of the laser pointer 950 and the first optical component in the module 900. Typically, the module 900 slides over the laser pointer 950 with a moderately snug fit.

In lieu of the laser pointer 950, the module 900 may be combined with a laser device other than a laser pointer, such as a laser module, or a portable laser other than a laser pointer such as a laser pointer like device that is unsuitable for use as a laser pointer.

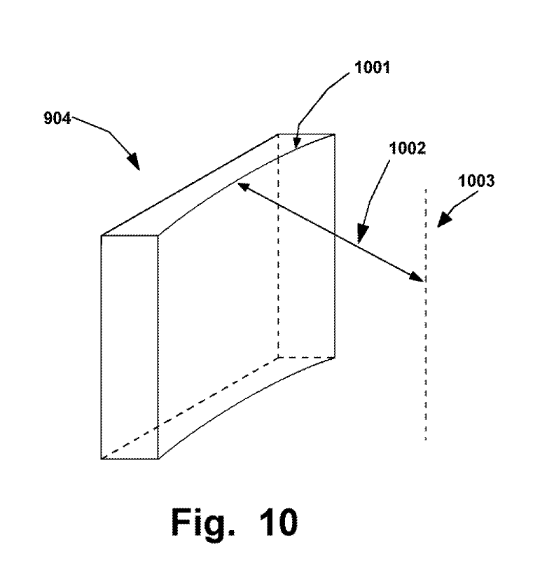

Referring to FIG. 10, an example embodiment of the concave cylindrical lens 904 of FIG. 9 is shown in greater detail. This concave cylindrical lens has a cylindrical surface 1001 having a radius 1002 from an axis 1003. Alternatively, the cylindrical surface 1001 may have a non-circular curvature, for example an elliptical or parabolic curvature.

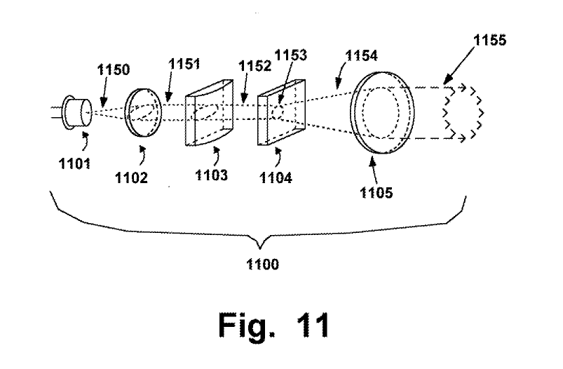

Referring to FIG. 11, an optical train 1100 is shown, in an example embodiment. The optical train 1100 has an overall function like that of the optical train 1 of FIGS. 1, 2, and 3, and the optical train 900 of FIG. 9. The optical train 1100 achieves this overall function entirely with convex lenses. Convex lenses, especially convex cylindrical lenses, are more widely available than concave ones.

The optical train 1100 comprises in part a laser diode 1101, a first non-cylindrical convex lens 1102 and a cylindrical convex lens 1103. A typically oblong diverging diode laser beam 1150 produced by the laser diode enters the first non-cylindrical convex lens 1102, and converges in a manner with constant or largely constant aspect ratio, in the form of a converging beam 1151. The converging beam next enters the cylindrical convex lens 1103. The converging beam 1151 is shown as entering the cylindrical convex lens 1103 before the converging beam 1151 converges to a point and rediverges, but alternatively it may enter the cylindrical convex lens 1102 afterwards.

The beam exits the cylindrical convex lens 1103 in the form of a beam 1152 that is converging in a manner such that the beam 1152 has a location 1153 where its cross section is not oblong, which is shown to occur where a diffuser 1104 is placed. The beam is shown as having its cross section's aspect ratio continuously decreasing as it progresses towards the diffuser 1104. Alternatively, the initially narrower dimension of the beam 1152 may converge into a line segment and rediverge before its width matches that of its initially wider dimension. The beam, after being processed by the diffuser 1104, progresses towards a second non-cylindrical convex lens 1105 in the form of a diffused beam 1154. The second non-cylindrical convex lens 1105 projects an image of the location 1153 where the beam 1152 strikes the diffuser 1104, to form an output beam 1155.

Numerous variant and alternative optical trains are suitable for causing an oblong laser beam to become non-oblong, for the purpose of achieving a non-oblong irradiation pattern on a diffuser, with a convex lens projecting an image of the irradiation pattern on the diffuser to achieve an output beam that is suitable for detection of fluorescent materials. For example, the cylindrical convex lens 1102 may process an oblong laser beam before the first non-cylindrical convex lens 1101 does.

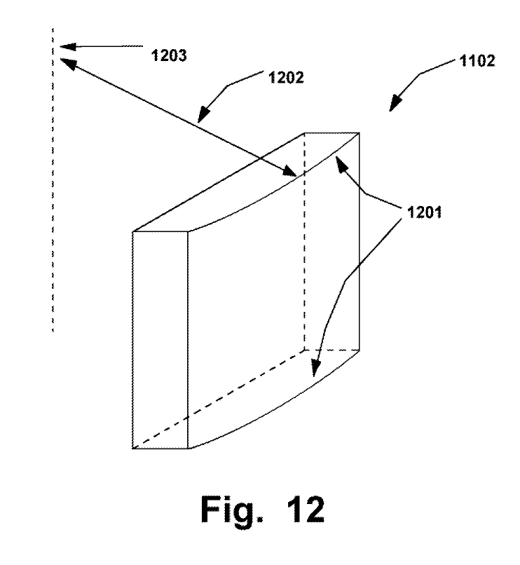

Referring to FIG. 12, in an example embodiment, the cylindrical convex lens 1102 is shown in greater detail, with a convex cylindrical curved surface 1201 having a radius 1202 from an axis 1203. The cylindrical convex lens 102 of FIGS. 1, 2, and 3 is typically similar in form.

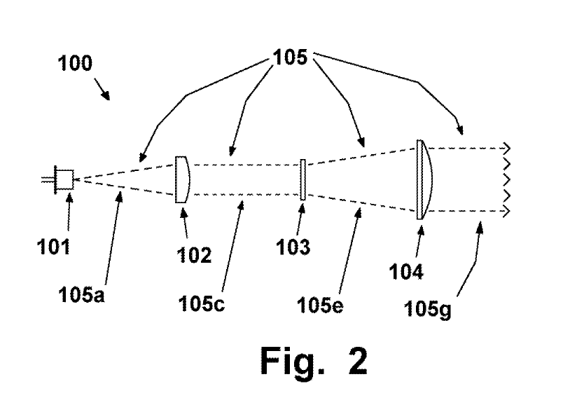

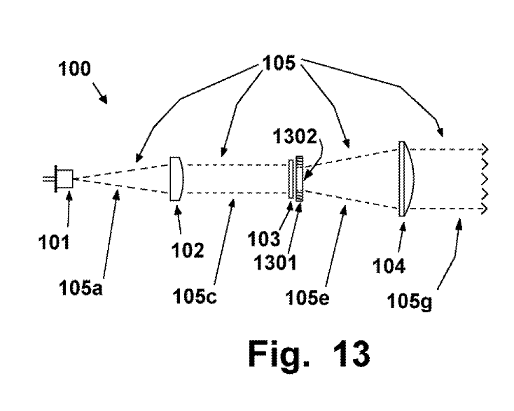

Referring to FIG. 13, in an example embodiment, the optical train 100 as shown above in FIG. 2 and having optical components 101-104 is shown again, but with an additional optical component, namely an opaque barrier 1301 with a preferably circular hole 1302, which is placed preferably adjacent to the diffuser 103. This optical component 1301/1302 may be in the form of a washer, and may be placed either before or after the diffuser 103.

The opaque barrier 1301 with a hole 1302 may be placed after the diffuser 103, as shown. In this case, the second non-cylindrical convex lens 104 preferably projects an image of the hole 1302 to form the output beam 105h.

Alternatively, if the opaque barrier 1160 with a suitably sized hole 1161 is placed before the diffuser 1103, especially if it is adjacent to the diffuser 1103, then the irradiation location 1154 on diffuser 1103 that gets irradiated by the beam 1152 has the shape of the hole 1161 and has a sharp edge. It will often be required to have the opaque barrier 1160 adjacent to the diffuser 1103 in order for the irradiation location 1154 to have a sharp edge and a neatened appearance. Subsequently, the second non-cylindrical convex lens 1104 projects an image of the thus tailored irradiation location 1154 to form the output beam 1156.

In some example embodiments, instead of the hole 1302, a lens can be included in the hole 1302. In other example embodiments, a transparency formed of transparent material can be included in the hole 1302. For example, the transparency can be a circular transparent region surrounded by a circular opaque barrier.

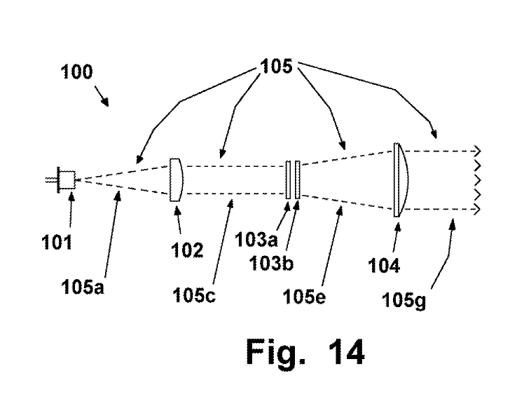

Referring to FIG. 14, in an example embodiment, an optical train 100a is shown as being like the above optical train 100 as depicted above in FIG. 2, except that a first diffuser 103a and a second diffuser 103b are used in place of the single diffuser 103. The two diffusers are typically spaced close together in comparison to the other spacings between optical components in the optical train 100a. Use of two diffusers instead of one typically reduces the visible presence of large scale speckle and other irregularities that are often present in the beam initially produced by a laser diode.

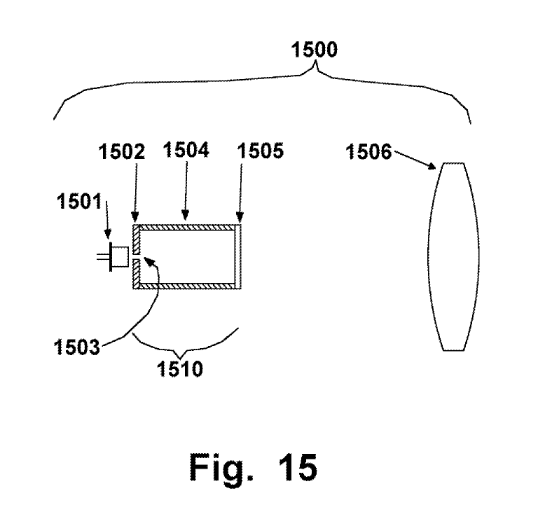

Referring to FIG. 15, in an example embodiment, an optical train 1500 is shown, comprising a laser diode 1501, a disc 1502 with an input interface such as a hole 1503, a tube 1504, an output interface such as a diffuser 1505, and a lens 1506. Laser radiation from the laser diode passes through the hole 1503, and most of it strikes the interior surface of the tube 1504. The interior surface of the tube 1504 is diffusely reflecting, and subsequently reflects the laser radiation in random directions. The interior surface of the tube 1504 may have its diffuse reflectivity enhanced by use of titanium dioxide. Some of the laser radiation reflected by the interior of the tube 1504 subsequently strikes the forward surface of the disc 1501, which may also have its diffuse reflectivity enhanced by use of titanium dioxide. Reflected laser radiation preferably continues to diffusely reflect in random directions until it strikes and passes through the diffuser 1505. Laser radiation striking the diffuser 1505 and not passing through it is diffusely reflected by it, mostly towards the diffusely reflective interior surface of the tube 1505 and forward surface of the disc 1502.

The forward surface of the disc 1502, the interior surface of the tube 1504, and the rear surface of the diffuser 1505 together comprise a diffuse reflection chamber 1510. Laser radiation within the diffuse reflection chamber 1510 preferably continues to be diffusely reflected by these surfaces until it passes through the diffuser 1505.

Some of the laser radiation passing through the hole 1503 is directed at the diffuser 1505 and strikes the diffuser 1505 without first being reflected by any diffusely reflective surfaces of the disc 1501 or tube 1504, and some of this laser radiation passes through the diffuser, and the remainder is diffusely reflected and joins other laser radiation being diffusely reflected around inside the diffuse reflection chamber 1510.

Once laser radiation passes through the diffuse reflection chamber 1510, much of it passes the lens 1506 and is collimated by the lens 1506 into a beam. The lens 1506 may project this beam in the form of an image of the forward surface of the diffuser 1505.

In other example embodiments, the diffuse reflection chamber 1510 can be other shapes other than a tube 1504, such as oval, ovoid, or rectangular.

In example embodiments where a concave lens is used for diverging a beam, it can be appreciated that a convex lens can be used in other example embodiments as a suitable replacement to the concave lens, wherein the beam is converged by the convex lens to a point and then rediverges at a suitable point downstream, therefore acting as a beam divering device.

Certain adaptations and modifications of the described embodiments can be made. Therefore, the above discussed embodiments are considered to be illustrative and not restrictive. Example embodiments described as methods would similarly apply to devices or systems, and vice-versa.

Variations may be made to some example embodiments, which may include combinations and sub-combinations of any of the above. The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

1. An inspection lamp for detection of fluorescent material with reduced visible laser speckle, comprising:
a laser device that generates radiation that is suitable for fluorescing the fluorescent material, wherein the laser device simultaneously outputs multiple individual laser wavelengths;
at least one diffuser that is positioned to diffuse the radiation; and
at least one lens which is shaped to form the radiation into a beam, the beam for detecting the fluorescent material.

2. The inspection lamp of claim 1, wherein the laser device further comprises a laser diode.

3. The inspection lamp of claim 1, wherein the laser diode generates radiation having a wavelength of on or about 445 nanometers.

4. The inspection lamp of claim 3, wherein the multiple individual laser wavelengths are within a range of 1 nanometer.

5. The inspection lamp of claim 3, wherein the multiple individual laser wavelengths are within a range of 2 nanometers.

6. The inspection lamp of claim 1, wherein the laser device further comprises a blue laser diode.

7. The inspection lamp of claim 1, wherein the multiple individual laser wavelengths are within a range of 1 nanometer.

8. The inspection lamp of claim 1, wherein the multiple individual laser wavelengths are within a range of 2 nanometers.

9. The inspection lamp of claim 1, wherein the multiple individual laser wavelengths comprise at least 20 different wavelengths.

10. The inspection lamp of claim 1, wherein the laser device generates a pulsed laser output.

11. The inspection lamp of claim 1, wherein the laser device further comprises a blue laser pointer.

12. The inspection lamp of claim 1, wherein at least one of the lenses is positioned between the laser device and at least one of the diffusers.

13. The inspection lamp of claim 1, wherein at least one of the lenses is positioned to shape the radiation from at least one of the diffusers.

14. The inspection lamp of claim 1, further comprising a collimation layer to collimate the radiation from the at least one diffuser.

15. The inspection lamp of claim 14, wherein the collimation layer comprises an opaque barrier defining a hole there through.

16. The inspection lamp of claim 14, wherein the collimation layer comprises at least one of the lenses.

17. The inspection lamp of claim 1, wherein at least one of the lenses is shaped to reduce an oblong shape of the radiation.

18. The inspection lamp of claim 17, wherein at least one of the diffusers is generally positioned where the radiation is non-oblong.

19. The inspection lamp of claim 1, further comprising a vibrator operably connected to at least one of the diffusers.

20. The inspection lamp of claim 1, further comprising a rotator operably connected to rotate at least one of the diffusers.

21. The inspection lamp of claim 1, wherein at least one lens is cylindrical.

22. The inspection lamp of claim 1, wherein at least one lens is astigmatic.

23. The inspection lamp of claim 1, further comprising a reflection chamber including an input interface for receiving the radiation, at least one reflective interior surface for reflecting at least some of the radiation, and an output interface.

24. The inspection lamp of claim 23, wherein the at least one reflective interior surface comprises a diffusive reflective surface.

25. The inspection lamp of claim 23, wherein the output interface comprises at least one of the diffusers.

26. An inspection system, comprising;
the inspection lamp of claim 1; and
a filter, independent of a beam path of the beam, that blocks at least part or all of the radiation produced by the beam to reduce visible laser speckle.

27. The system of claim 26, wherein the filter comprises a pair of goggles.

28. The system of claim 27, wherein the goggles are yellow.

29. The system of claim 26, wherein the filter passes at least some or all of a fluorescence spectrum from the fluorescent material resulting from the beam.

30. The system of claim 26, further comprising the fluorescent material.

31. A method of detecting fluorescent material with reduced visible laser speckle, comprising:
generating radiation from a laser device that is suitable for fluorescing the fluorescent material, wherein the laser device simultaneously outputs multiple individual laser wavelengths;
diffusing the radiation using at least one diffuser;
shaping the radiation into a beam using at least one lens; and
irradiating a region of interest with the beam, for detecting of the fluorescent material.

32. The method of claim 31, further comprising, using a filter independent of a beam path of the beam, blocking at least part or all of the radiation produced by the beam to reduce visible laser speckle.

33. The method of claim 32, wherein the filter comprises a pair of goggles.

34. The method of claim 33, wherein the goggles are yellow.

35. The method of claim 31, wherein the laser device generates radiation having a wavelength of on or about 445 nanometers.

36. The method of claim 31, wherein the filter passes at least some or all of a fluorescence spectrum from the fluorescent material resulting from the beam.
